(19) United States
(12) Patent Application Publication
(10) Pub. No.: US 2008/0193670 A1
(43) Pub. Date: Aug. 14, 2008

(54) METHOD FOR MANUFACTURING ORGANIC ELECTROLUMINESCENT ELEMENT AND METHOD FOR MANUFACTURING DISPLAY

(75) Inventors: Shigeyuki Matsunami, Kanagawa (JP); Yasunori Kijima, Tokyo (JP); Tatsuya Matsumi, Kanagawa (JP); Tadahiko Yoshinaga, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/015,298

(22) Filed: Jan. 16, 2008

(30) Foreign Application Priority Data
Feb. 8, 2007 (JP) JP 2007-028744

(51) Int. Cl. B05D 5/12; B05D 3/14

(52) U.S. Cl. 427/532

(57) ABSTRACT

A method for manufacturing an organic electroluminescent element, the method includes the step of after forming the organic electroluminescent element obtained by interposing an emission layer composed of an organic material between an anode and a cathode, decreasing an operating voltage of the organic electroluminescent element by applying a voltage higher than the operating voltage of the organic electroluminescent element between the anode and the cathode.

### CROSS REFERENCE TO RELATED APPLICATIONS

The present application claims priority related to Japanese Patent Application JP 2007-028744 filed with the Japan Patent Office on Feb. 8, 2007, the entire contents of which is being incorporated herein by reference.

### BACKGROUND

The present application relates to a method for manufacturing an organic electroluminescent element and a method for manufacturing a display, and particularly to manufacturing methods suitable for manufacturing of an organic electroluminescent element that has an electrode formed by using an aluminum alloy and manufacturing of a display employing the organic electroluminescent element.

In recent years, displays employing organic electroluminescent elements (so-called organic EL elements) are attracting attention as flat panel displays that have low power consumption, high response speed, and no viewing-angle dependence.

In general, the organic electroluminescent element has an organic layer interposed between its cathode and anode, and emits light due to the recombination of holes and electrons injected from the anode and the cathode in the organic layer. As the structure of the organic layer, there have been developed e.g. a structure obtained by sequentially stacking a hole transport layer, an emission layer containing a light-emitting material, and an electron transport layer in that order from the anode side, and a structure in which a light-emitting material is contained in an electron transport layer to thereby use this layer as an electron-transport emission layer.

For an active-matrix display in which thin film transistors (hereinafter, TFTs) for driving the respective organic electroluminescent elements are provided over a substrate, it is advantageous to have a top-emission structure, which allows light emitted by the organic electroluminescent element to be extracted from the opposite side to the substrate, in terms of enhancement in the aperture ratio of the light-emitting part. The enhancement in the aperture ratio can decrease the density of the current applied to the respective elements in order to obtain the demanded luminance, and thus can extend the element lifetime.

In the organic electroluminescent element with such a top-emission structure, generally the anode provided on the substrate side is used as a reflective electrode and the cathode provided on the light extraction side is used as a transparent or semi-transparent electrode. Therefore, in order to efficiently extract emitted light from the cathode side, it is demanded to form the anode by using a material with high reflectivity.

As the material for forming an anode having favorable reflectivity, e.g. silver (Ag), an alloy containing silver, and an aluminum (Al) alloy have been proposed (refer to e.g. Japanese Patent Laid-open No. 2003-77681 and Japanese Patent Laid-open No. 2003-234193 (Patent Documents 1 and 2, respectively)). According to Patent Document 2, when an anode is formed by using an aluminum (Al) alloy in particular, in order to cover the low work function of aluminum, it is preferable to mix copper (Cu), palladium (Pd), gold (Au), nickel (Ni), platinum (Pt), or the like having a high work function as a minor-component metal to about 20 to 30% to thereby suppress increase in the operating voltage.

Besides the above-described structures, there has also been proposed a structure in which an anode with a multilayer structure is formed by forming an indium tin oxide (ITO) film, which is publicly-known as an anode material, as a transparent electrode and then evaporating aluminum or silver as the above-mentioned highly-reflective metal on the ITO film. Furthermore, there has also been proposed a layer structure in which the metal surface is oxidized according to need to thereby turn the anode to a non-conductive layer (refer to Japanese Patent Laid-open No. 2006-503443 (Patent Document 3)).

In addition, there has been proposed a structure in which an aluminum alloy (e.g. aluminum/neodymium alloy) containing a lanthanoid series element, which is a comparatively inexpensive metal material, is used as the material of an anode composed mainly of aluminum. According to this proposal, in an organic electroluminescent element employing such an aluminum alloy for its anode, high efficiency attributed to high reflectivity of the anode is realized. Furthermore, a highly-reliable organic electroluminescent element having enhanced anode stability and a display employing the same are achieved (refer to Japanese Patent Laid-open No. 2006-79836 (Patent Document 4)).

It is known that the above-described organic electroluminescent element shows a phenomenon that the light emission luminance thereof decreases along with the elapse of the light emission time, particularly in the initial period of the light emission time. Therefore, in manufacturing of an organic electroluminescent element and a display employing it, aging treatment is carried out with a current density about five to one thousand times the current density in element driving, in order to stabilize the lowering of the light emission luminance accompanying the elapse of the light emission time. As a method of the aging treatment, there has been proposed e.g. a method in which a forward voltage is applied and then a reverse voltage is applied (refer to Japanese Patent Laid-open No. 2005-310758 (Patent Document 5)).

As another problem of the above-described organic electroluminescent element, certain pixels often become incapable of emitting light due to the short-circuit between the cathode and the anode, and the whole of the elements often become incapable of emitting light due to the flowing of almost all the current through a short-circuited part. To address this problem, there has been proposed a driving method that allows the light emission of organic electroluminescent elements even when there is a short-circuited part. In this method, at the start of element driving, a high voltage surpassing the voltage applied in constant-current driving is applied to thereby generate a large current. This causes the short-circuited part to generate heat and be oxidized so as to be repaired (refer to Japanese Patent Laid-open No. 2003-59652 (Patent Document 6)).

Moreover, there is also a report that the operating voltage of the above-described organic electroluminescent element increases as a result of the staying of the element at a comparatively high temperature for a certain period. As a method for preventing this problem, there has been proposed a manufacturing method in which a bias voltage is applied while an anode is heated and thereafter an organic emission layer and a cathode are formed (refer to Japanese Patent Laid-open No. 2005-285337 (Patent Document 7)).

As described above, various kinds of voltage application steps for characteristic improvement are carried out in a manufacturing step for an organic electroluminescent element. However, the organic electroluminescent element employing an aluminum/neodymium alloy for its anode involves a problem that, even after the voltage application step, the operating voltage thereof remains high and the voltage-current characteristic thereof varies.

### SUMMARY

In an embodiment, a method for manufacturing an organic electroluminescent element that has favorable characteristics including a decreased operating voltage and suppressed variation in the voltage-current characteristic, and a method for manufacturing a display employing the same are provided.

In a method for manufacturing an organic electroluminescent element and a method for manufacturing a display according to an embodiment, initially an organic electroluminescent element obtained by interposing an emission layer composed of an organic material between an anode and a cathode is formed. Subsequently, the operating voltage of the organic electroluminescent element is decreased by applying a voltage higher than the operating voltage of the organic electroluminescent element between the anode and the cathode.

In the decreasing of the operating voltage, the voltage is applied for a period (e.g. ten seconds or shorter) sufficiently shorter than the voltage application time in the aging treatment for the light emission luminance, described in Patent Document 5. Furthermore, the application voltage is higher than the operating voltage of the organic electroluminescent element but is lower than the voltage applied in the treatment for repairing a short-circuited part, described in Patent Document 6, and has a voltage value that allows the decreasing of the operating voltage of the organic electroluminescent element.

It is confirmed that, according to the above-described manufacturing methods, the operating voltage of an organic electroluminescent element is decreased by applying a voltage higher than the operating voltage after forming the configuration as the organic electroluminescent element. Furthermore, it is confirmed that this method can decrease the operating voltage even for an organic electroluminescent element employing an aluminum/neodymium alloy for its anode, of which operating voltage is particularly difficult to decrease in related arts. In addition, it is also confirmed that variation in the voltage-current characteristic is suppressed in an organic electroluminescent element manufactured through such voltage-decrease treatment.

As described above, the manufacturing methods according to the aspects can provide an organic electroluminescent element that has favorable characteristics including a decreased operating voltage and suppressed variation in the voltage-current characteristic, and can reduce the power consumption of a display employing the organic electroluminescent elements.

Additional features and advantages are described herein, and will be apparent from, the following Detailed Description and the figures.

### BRIEF DESCRIPTION OF THE FIGURES

FIG. 1 is a flowchart showing one example of a manufacturing procedure according to an embodiment;

FIG. 2 is a sectional view of an organic electroluminescent element according to the embodiment;

FIGS. 3A and 3B are diagrams showing one example of the circuit arrangement in a display obtained by a manufacturing method according to the embodiment;

FIG. 4 is a structural diagram showing a module-shape display having a sealed structure obtained by applying the manufacturing method according to the embodiment;

FIG. 5 is a perspective view showing a television to which the embodiment is applied;

FIGS. 6A and 6B are diagrams showing a digital camera to which the embodiment is applied: FIG. 6A is a front-side perspective view and FIG. 6B is a rear-side perspective view;

FIG. 7 is a perspective view showing a notebook personal computer to which the embodiment is applied;

FIG. 8 is a perspective view showing a video camera to which the embodiment is applied; and

FIGS. 9A to 9G are diagrams showing a cellular phone as portable terminal apparatus to which the embodiment is applied: FIGS. 9A and 9B are a front view and side view, respectively, of the opened state, and FIGS. 9C, 9D, 9E, 9F, and 9G are a front view, left-side view, right-side view, top view, and bottom view, respectively, of the closed state.

### DETAILED DESCRIPTION

A method for manufacturing an organic electroluminescent element and a method for manufacturing a display according to embodiments of the present application will be described in detail below based on the drawings.

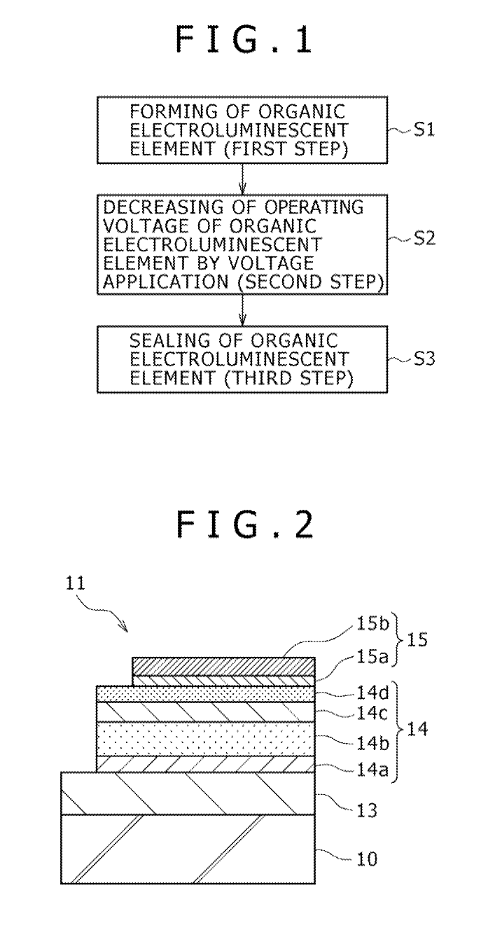

FIG. 1 is a flowchart showing a manufacturing method of the embodiment. As shown in this flowchart, in the embodiment, initially a step of forming an organic electroluminescent element over a substrate is carried out as a first step (S1).

Thereafter, as a second step (S2), a voltage higher than the operating voltage of the formed organic electroluminescent element is applied between the anode and cathode of the organic electroluminescent element, to thereby decrease the operating voltage of the organic electroluminescent element.

Furthermore, a third step (S3) of sealing the organic electroluminescent element is carried out according to need after the second step (S2), or between the first step (S1) and the second step (S2).

Details of the first step (S1) to the third step (S3) will be described below in that order.

Referring to FIG. 2, in formation of an organic electroluminescent element 11 in the first step (S1), an anode 13 is pattern-formed on a substrate 10. Subsequently, an organic layer 14 that is composed of organic materials and includes an emission layer 14c, and a cathode 15 are stacked over the anode 13 in that order. In the present example, the organic electroluminescent element 11 is formed as a top-emission element from which light is extracted from the opposite side to the substrate 10. In the case of forming a display, plural organic electroluminescent elements 11 are arranged over the substrate 10. Details of the respective components in the organic electroluminescent element 11 are as follows.

The substrate 10 is a support member, and the organic electroluminescent elements 11 are arranged on one major surface side thereof. A publicly-known material may be used for the substrate 10, and e.g. quartz, glass, metal foil, resin film, or resin sheet is used as the substrate 10. Of these materials, quartz and glass are preferable. Examples of the resin material for the substrate 10 include methacrylic resins typified by polymethylmethacrylate (PMMA), polyesters such as polyethylene terephthalate (PET), polyethylene naphthalate (PEN), and polybutylene naphthalate (PBN), and polycarbonates. However, when a resin material is used, it is necessary for the substrate 10 to have a multilayer structure or be subjected to surface treatment for suppressing water permeability and gas permeability.

Over the substrate 10, pixel circuits each including a drive thin film transistor (TFT) and drive circuits for driving the pixel circuits are provided according to need, and these circuits are covered by an insulating film. The detailed configurations of the pixel circuits and so on will be described later.

The anode 13 provided on the substrate 10 is formed by using an alloy layer (aluminum alloy layer) composed mainly of aluminum. The minor component of this aluminum alloy contains an element of which work function is lower than that of aluminum.

As the minor component, a lanthanoid series element is preferable. Although the work function of the lanthanoid series elements is not high, the presence of any of these elements enhances the stability of the anode and allows the anode to achieve favorable hole injection property. As the minor component, besides a lanthanoid series element, another element such as silicon (Si) or copper (Cu) may be contained.

It is preferable that the amount of the minor component metal in the aluminum alloy layer be about 10 wt % or lower. Such minor-component content maintains the reflectivity of the aluminum alloy layer and stably keeps the aluminum alloy layer in the manufacturing process for the organic electroluminescent element. Furthermore, favorable processing accuracy and chemical stability are also achieved. In addition, the electric conductivity of the anode 13 and the adhesion thereof with the substrate 10 are also kept favorable.

The anode 13 may include the aluminum alloy layer as a first layer and have a second layer superior in the optical transparency as a layer in contact with the organic layer 14. Examples of such a second layer include a layer composed of at least one of an oxide of the aluminum alloy layer (first layer), an oxide of molybdenum, an oxide of zirconium, an oxide of chromium, and an oxide of tantalum. For example, when the second layer is composed of an oxide (including a natural oxide film) of an aluminum alloy and the minor component of the aluminum alloy layer as the first layer contains a lanthanoid series element, high reflectivity can be kept at the surface of the aluminum alloy layer because an oxide of a lanthanoid series element has high transmittance. The second layer may be a transparent conductive layer such as an indium tin oxide (ITO) or indium zinc oxide (IZO) layer. These conductive layers can improve the hole injection property of the anode.

On the other hand, on the surface of the anode 13 in contact with the substrate 10, a conductive layer for enhancing the adhesion between the anode 13 and the substrate 10 may be provided. Examples of such a conductive layer include a transparent conductive layer such as an ITO or IZO layer.

When the drive system for the display formed by using the organic electroluminescent elements 11 is the active-matrix system, the anodes 13 are patterned on a pixel-by-pixel basis and so provided as to be connected to drive TFTs provided on the substrate 10. Furthermore, an insulating film (not shown) is provided on the anodes 13 in such a way that the surfaces of the anodes 13 of the respective pixels are exposed through apertures in this insulating film.

The organic layer 14 deposited on the anode 13 is obtained e.g. by sequentially stacking four layers of a hole injection layer 14a, a hole transport layer 14b, the emission layer 14c, and an electron transport layer 14d in that order from the anode side. For the respective layers 14a to 14d, a compound that emits fluorescence or phosphorescence in response to electric field application thereto and compounds having capability for transporting electrons or holes are properly used.

The hole injection layer 14a and the hole transport layer 14b each function to enhance the efficiency of hole injection into the emission layer 14c. Examples of the material of the hole injection layer 14a and the hole transport layer 14b include benzine, styrylamine, triphenylamine, porphyrin, triazole, imidazole, oxadiazole, polyarylalkane, phenylenediamine, arylamine, oxazole, anthracene, fluorenone, hydrazone, stilbene, and derivatives of these substances. In addition, the examples of the material further include heterocyclic conjugated monomers, oligomers, and polymers, such as polysilane compounds, vinylcarbazole compounds, thiophene compounds, and aniline compounds.

More specific examples of the material of the hole injection layer 14a and the hole transport layer 14b include α-naphthylphenyldiamine, porphyrin, metal tetraphenylporphyrin, metal naphthalocyanine, 4,4,4-tris(3-methylphenylphenylamino)triphenylamine, N,N,N′,N′-tetrakis(p-tolyl)-p-phenylenediamine, N,N,N′,N′-tetraphenyl-4,4′-diaminobiphenyl, N-phenylcarbazole, 4-di-p-tolylaminostilbene, poly(paraphenylenevinylene), poly(thiophenevinylene), and poly(2,2′-thienylpyrrol). However, the material is not limited to these substances.

In particular, as the compound for forming the hole injection layer 14a, a compound represented by General formula (1) is preferably used.

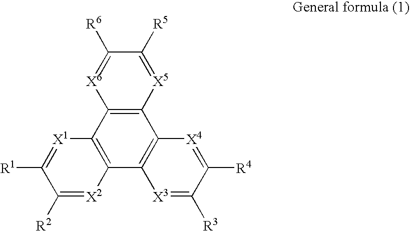

In General formula (1), R¹ to R⁶ are each independently a substituent selected from hydrogen, a halogen, hydroxyl group, amino group, arylamino group, substituted or unsubstituted carbonyl group having 20 or less carbon atoms, substituted or unsubstituted carbonyl ester group having 20 or less carbon atoms, substituted or unsubstituted alkyl group having 20 or less carbon atoms, substituted or unsubstituted alkenyl group having 20 or less carbon atoms, substituted or unsubstituted alkoxyl group having 20 or less carbon atoms, substituted or unsubstituted aryl group having 30 or less carbon atoms, substituted or unsubstituted heterocyclic group having 30 or less carbon atoms, nitrile group, cyano group, nitro group, and silyl group. Of these R¹ to R⁶, adjacent R^{m}(m=1 to 6) may be coupled to each other via a ring structure. Furthermore, X¹ to X⁶ in General formula (1) are each independently a carbon or nitrogen atom.

Specific examples of the structure of the compound represented by General formula (1) include the structures represented by Structural formulas (1)-1 to (1)-64 shown below.

TABLE 1-1

| | |
|---|---|
| Structuralformula(1)-1 | 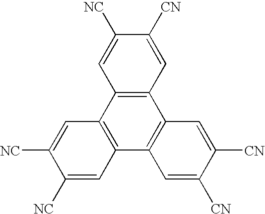 |
| Structuralformula(1)-2 | 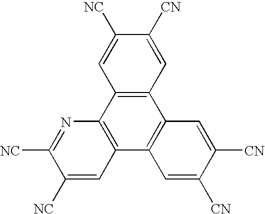 |
| Structuralformula(1)-3 | 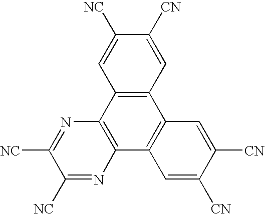 |
| Structuralformula(1)-4 | 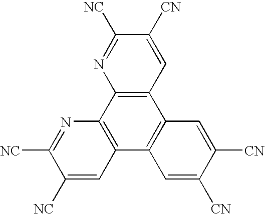 |
| Structuralformula(1)-5 | 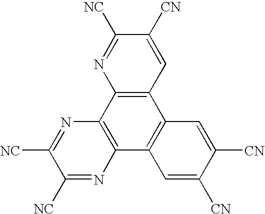 |
| Structuralformula(1)-6 | 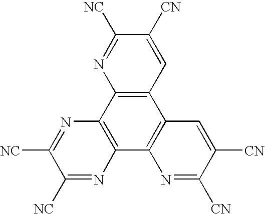 |
| Structuralformula(1)-7 | 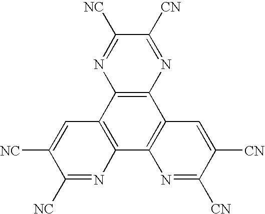 |
| Structuralformula(1)-8 | 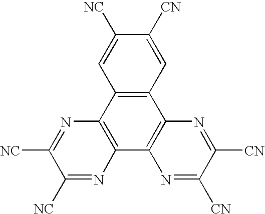 |
| Structuralformula(1)-9 | 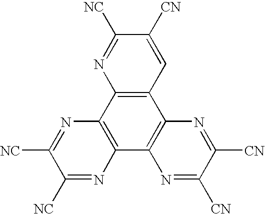 |
| Structuralformula(1)-10 | 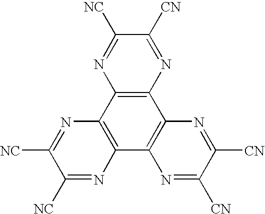 |

TABLE 1-2

| | |
|---|---|
| Structuralformula(1)-11 | 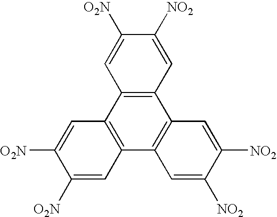 |
| Structuralformula(1)-12 | 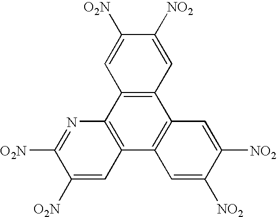 |
| Structuralformula(1)-13 | 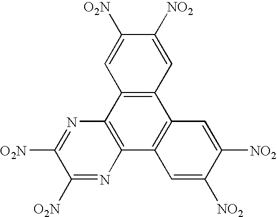 |
| Structuralformula(1)-14 | 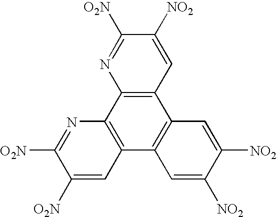 |
| Structuralformula(1)-15 | 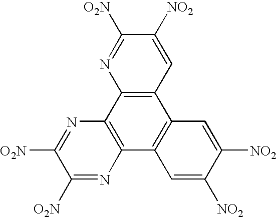 |
| Structuralformula(1)-16 | 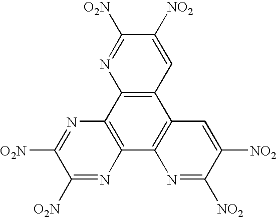 |
| Structuralformula(1)-17 | 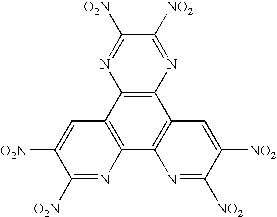 |
| Structuralformula(1)-18 | 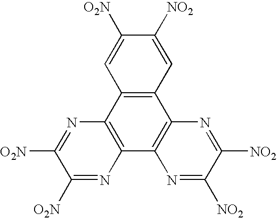 |
| Structuralformula(1)-19 | 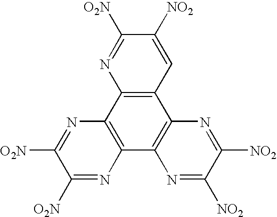 |
| Structuralformula(1)-20 | 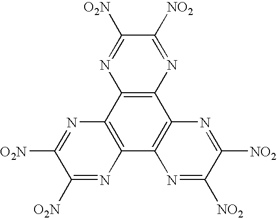 |
| Structuralformula(1)-21 | 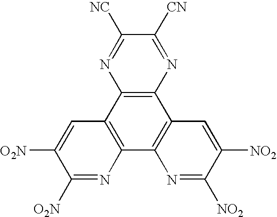 |
| Structuralformula(1)-22 | 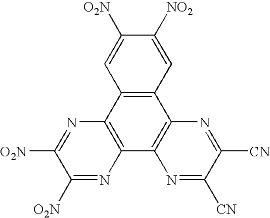 |

TABLE 1-3

| | |
|---|---|
| Structuralformula(1)-23 | 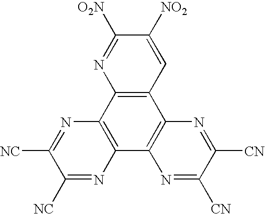 |
| Structuralformula(1)-24 | 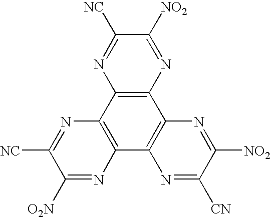 |
| Structuralformula(1)-25 | 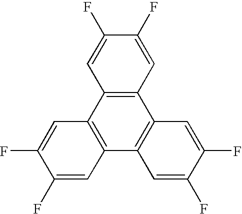 |
| Structuralformula(1)-26 | 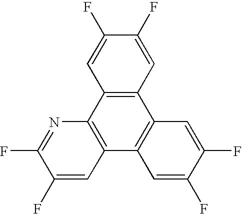 |
| Structuralformula(1)-27 | 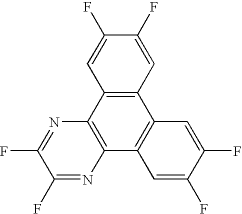 |
| Structuralformula(1)-28 | 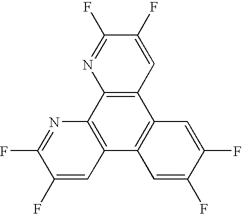 |
| Structuralformula(1)-29 | 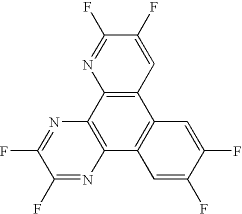 |
| Structuralformula(1)-30 | 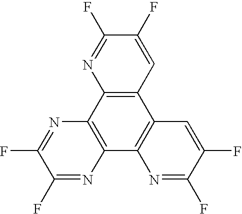 |
| Structuralformula(1)-31 | 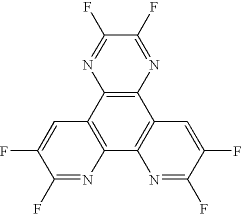 |
| Structuralformula(1)-32 | 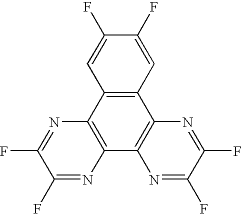 |
| Structuralformula(1)-33 | 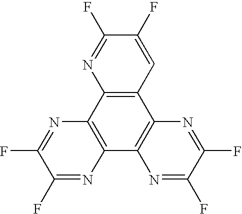 |
| Structuralformula(1)-34 | 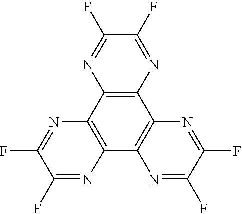 |

TABLE 1-4

| | |
|---|---|
| Structuralformula(1)-35 | 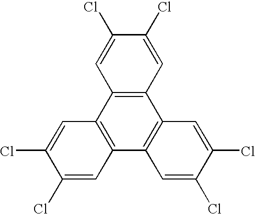 |
| Structuralformula(1)-36 | 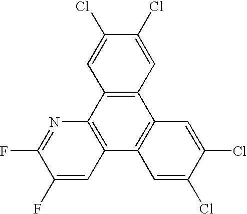 |
| Structuralformula(1)-37 | 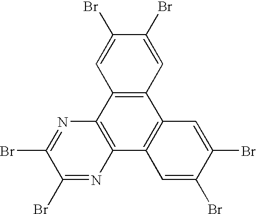 |
| Structuralformula(1)-38 | 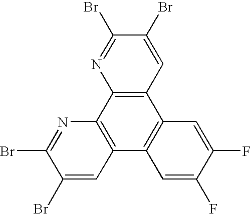 |
| Structuralformula(1)-39 | 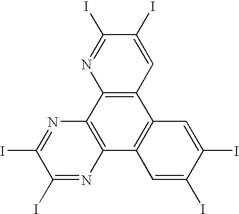 |
| Structuralformula(1)-40 | 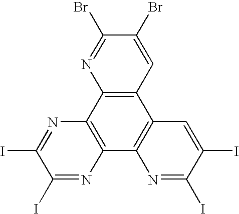 |
| Structuralformula(1)-41 | 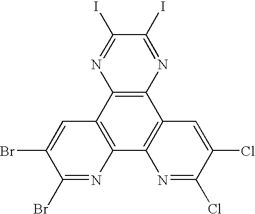 |
| Structuralformula(1)-42 | 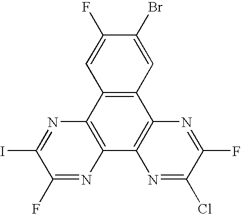 |
| Structuralformula(1)-43 | 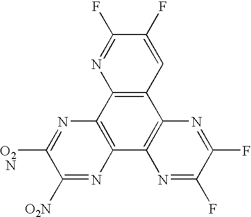 |
| Structuralformula(1)-44 | 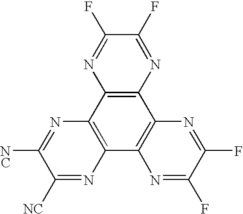 |
| Structuralformula(1)-45 | 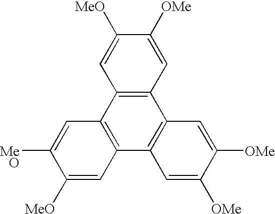 |
| Structuralformula(1)-46 | 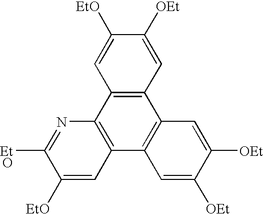 |

TABLE 1-5

| | |
|---|---|
| Structuralformula(1)-47 | 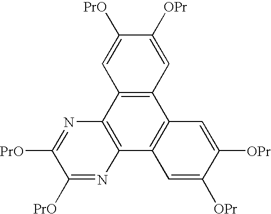 |
| Structuralformula(1)-48 | 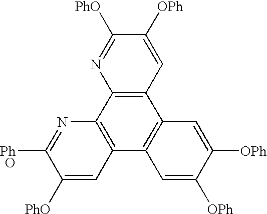 |
| Structuralformula(1)-49 | 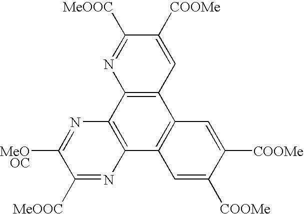 |
| Structuralformula(1)-50 | 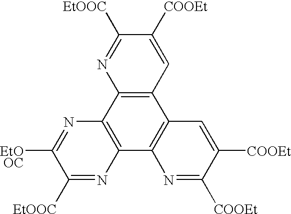 |
| Structuralformula(1)-51 | 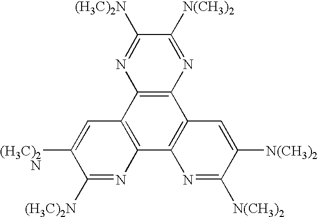 |
| Structuralformula(1)-52 | 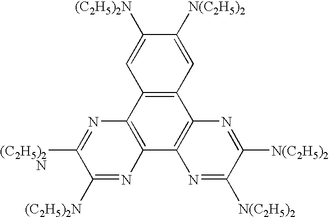 |
| Structuralformula(1)-53 | 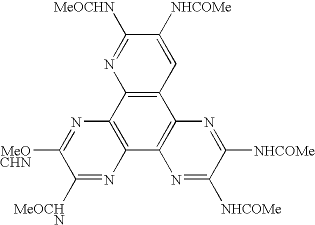 |
| Structuralformula(1)-54 | 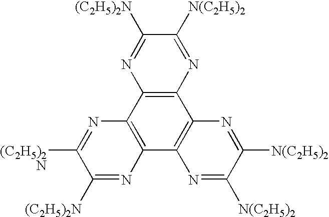 |
| Structuralformula(1)-55 | 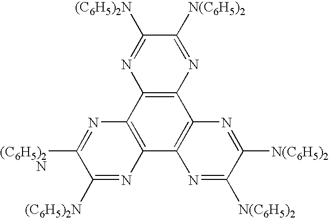 |
| Structuralformula(1)-56 | 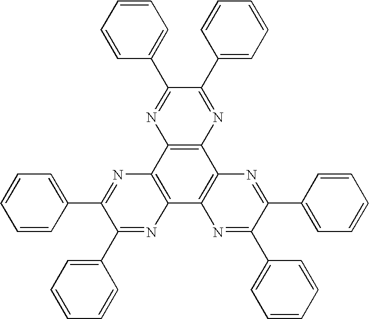 |

TABLE 1-6

| | |
|---|---|
| Structuralformula(1)-57 | 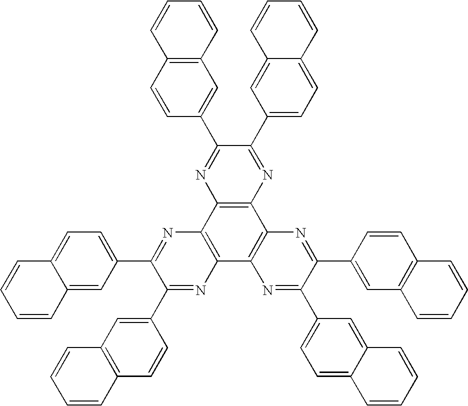 |
| Structuralformula(1)-58 | 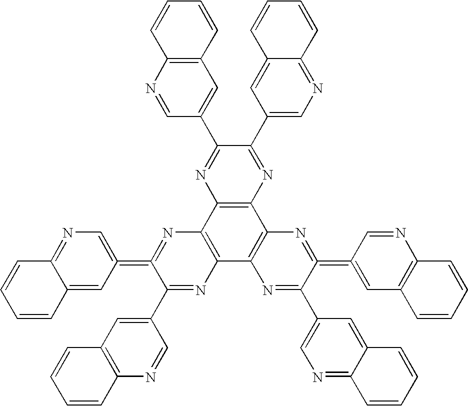 |
| Structuralformula(1)-59 | 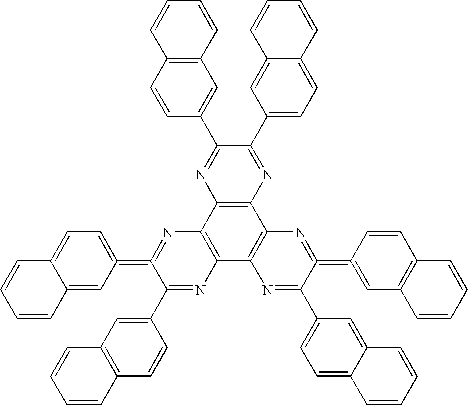 |
| Structuralformula(1)-60 | 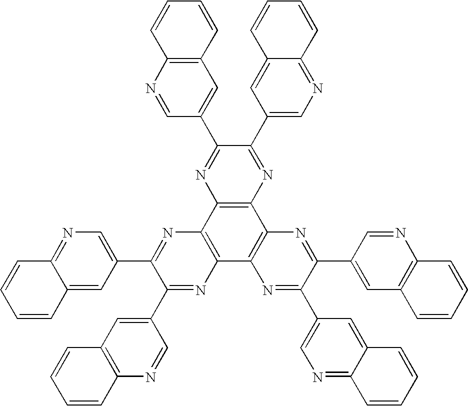 |
| Structuralformula(1)-61 | 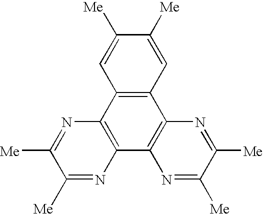 |
| Structuralformula(1)-62 | 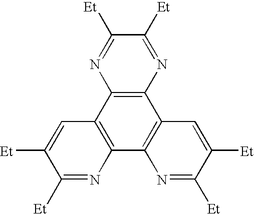 |
| Structuralformula(1)-63 | 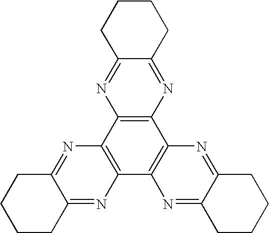 |
| Structuralformula(1)-64 | 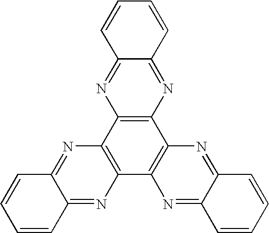 |

As another preferable example of the compound for forming the hole injection layer 14a, a compound represented by General formula (2) is also available.

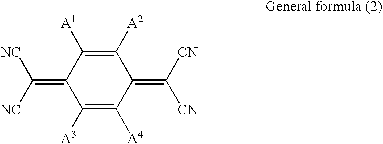

In General formula (2), A¹ to A⁴ are each independently a substituent selected from hydrogen, a halogen, hydroxyl group, amino group, arylamino group, substituted or unsubstituted carbonyl group having 20 or less carbon atoms, substituted or unsubstituted carbonyl ester group having 20 or less carbon atoms, substituted or unsubstituted alkyl group having 20 or less carbon atoms, substituted or unsubstituted alkenyl group having 20 or less carbon atoms, substituted or unsubstituted alkoxyl group having 20 or less carbon atoms, substituted or unsubstituted aryl group having 30 or less carbon atoms, substituted or unsubstituted heterocyclic group having 30 or less carbon atoms, nitrile group, cyano group, nitro group, and silyl group. Of these A¹ to A⁴, adjacent A^{m}(m=1 to 4) may be coupled to each other via a ring structure.

Specific examples of the structure of the compound represented by General formula (2) include the structures represented by Structural formulas (2)-1 to (2)-16 shown below.

TABLE 2-1

| | |
|---|---|
| Structuralformula(2)-1 | 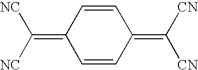 |
| Structuralformula(2)-2 | 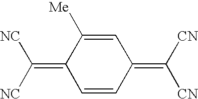 |
| Structuralformula(2)-3 | 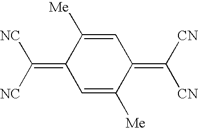 |
| Structuralformula(2)-4 | 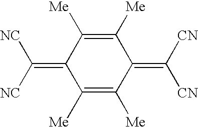 |
| Structuralformula(2)-5 | 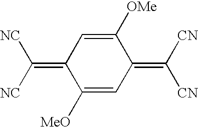 |
| Structuralformula(2)-6 | 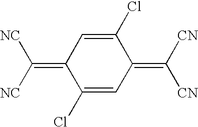 |
| Structuralformula(2)-7 | 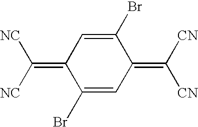 |
| Structuralformula(2)-8 | 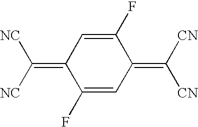 |
| Structuralformula(2)-9 | 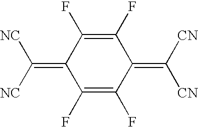 |
| Structuralformula(2)-10 | 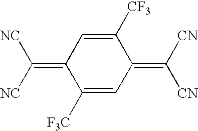 |
| Structuralformula(2)-11 | 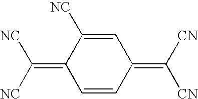 |
| Structuralformula(2)-12 | 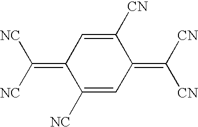 |

TABLE 2-2

| | |
|---|---|
| Structuralformula(2)-13 | 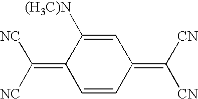 |
| Structuralformula(2)-14 | 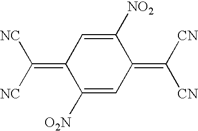 |
| Structuralformula(2)-15 | 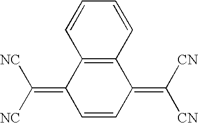 |
| Structuralformula(2)-16 | 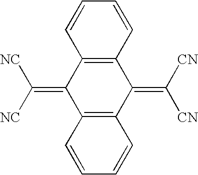 |

For the hole injection layer 14a, the compound represented by General formula (1) or (2) can be used alone. Alternatively, it is also possible to use the compound together with a tertiary amine such as α-naphthylphenyldiamine, 4,4,4-tris(3-methylphenylphenylamino)triphenylamine, N,N,N′,N′-tetrakis(p-tolyl)-p-phenylenediamine, or N,N,N′,N′-tetraphenyl-4,4′-diaminobiphenyl.

The emission layer 14c is the region in which holes injected from the anode 13 and electrons injected from the cathode 15 are recombined with each other when voltage is applied between the anode 13 and the cathode 15. The emission layer 14c is formed by using a material offering high light emission efficiency, specifically, e.g. an organic light-emitting material such as a low-molecular fluorescent dye, fluorescent polymer, or metal complex.

Specific examples of the material of the emission layer 14c include anthracene, naphthalene, indene, phenanthrene, pyrene, naphthacene, triphenylene, perylene, picene, fluoranthene, acephenanthrylene, pentaphene, pentacene, coronene, butadiene, coumarin, acridine, stilbene, and derivatives of these substances. In addition, the examples of the material further include tris(8-quinolinolato)aluminum complex, and bis(benzoquinolinolato)beryllium complex, tri(dibenzoylmethyl)phenanthroline europium complex, and ditoluyl vinylbiphenyl.

Any of the above-described materials is used as the host material. Furthermore, as a guest material, a material offering high light emission efficiency, specifically, e.g. an organic light-emitting material such as a low-molecular fluorescent dye, fluorescent polymer, or metal complex is used. Examples of such a guest material include organic substances such as naphthalene derivatives, anthracene derivatives, pyrene derivatives, naphthacene derivatives, perylene derivatives, coumarin derivatives, and pyran dyes. Of these substances, an aromatic tertiary amine compound is preferably used.

The electron transport layer 14d provided on the emission layer 14c having the above-described structure functions to transport electrons injected from the cathode 15 into the emission layer 14c. Examples of the material of the electron transport layer 14d include quinoline, perylene, bisstyryl, pyrazine, triazole, oxazole, oxadiazole, fluorenone, and derivatives of these substances. Specific examples of the material include tris(8-hydroxyquinoline)aluminum(Alq3), anthracene, naphthalene, phenanthrene, pyrene, perylene, butadiene, coumarin, acridine, stilbene, and derivatives of these substances.

The respective layers 14a to 14d of the organic layer 14 can be formed by a method such as vacuum evaporation or spin-coating.

The structure of the organic layer 14 is not limited to such a layer structure, but a multilayer structure according to need can be selected as long as the structure includes at least the emission layer 14c and the hole injection layer 14a or the hole transport layer 14b between the anode 13 and the emission layer 14c.

The emission layer 14c may be provided in the organic electroluminescent element 11 as a hole-transport emission layer, electron-transport emission layer, or emission layer that can transport both holes and electrons. Furthermore, each of the layers included in the organic layer 14, such as the hole injection layer 14a, the hole transport layer 14b, the emission layer 14c, and the electron transport layer 14d, may have a multilayer structure formed of plural layers.

The cathode 15 formed on the organic layer 14 with the above-described structure has e.g. a two-layer structure formed by stacking a first layer 15a and a second layer 15b in that order from the organic layer side.

The first layer 15a is formed by using a material that has a low work function and favorable optical transparency. As such a material, e.g. lithium oxide (Li2O) as an oxide of lithium (Li), cesium oxide (Cs2O) as an oxide of cesium (Cs), or a mixture of these oxides can be used. The material of the first layer 15a is not limited to these substances. Other examples of the material include alkaline earth metals such as calcium (Ca) and barium (Ba), alkali metals such as lithium and cesium, low-work-function metals such as indium (In) and magnesium (Mg), and oxides of these metals. Any of these metals and oxides may be used alone, or alternatively a mixture or alloy of these metals and oxides may be used with enhanced stability.

The second layer 15b is formed of an optically-transparent thin film composed of e.g. MgAg. This second layer 15b may be a mixed layer that further contains an organic light-emitting material such as an alumiquinoline complex, styrylamine derivative, or phthalocyanine derivative. In this case, an optically-transparent layer such as an MgAg layer may be further provided as a third layer.

The respective layers of the cathode 15 can be formed by a method such as vacuum evaporation, sputtering, or plasma CVD. When the drive system for the display formed by using the organic electroluminescent elements 11 is the active-matrix system, the cathode 15 is so formed over the substrate 10 in a blanket-film state as to be isolated from the anode 13 by the organic layer 14 and the above-described insulating film (not shown), and is used as a common electrode for the respective pixels.

It should be obvious that the structure of the cathode 15 is not limited to the above-described multilayer structure but the cathode 15 may employ the optimum film combination and multilayer structure depending on the configuration of the device to be fabricated. For example, the structure of the cathode 15 in the embodiment is a multilayer structure in which the functions of the respective layers in the electrode are separated, i.e., an inorganic layer (first layer 15a) for promoting electron injection into the organic layer 14 and an inorganic layer (second layer 15b) serving as the electrode are provided. However, the inorganic layer for promoting electron injection into the organic layer 14 may function also as the inorganic layer serving as the electrode. That is, these layers may be formed as a single-layer structure. Furthermore, it is also possible for the cathode 15 to have a multilayer structure obtained by forming a transparent electrode such as an ITO electrode on this single-layer structure.

The above-described organic electroluminescent element 11 may be formed to have a cavity structure. In this case, the sum of the film thicknesses of the organic layer 14 and the electrode layers composed of a transparent material or semi-transparent material is defined by the wavelength of the emitted light, and is set to the value derived from a calculation of multiple interference. Furthermore, in the case of a so-called TAC (top emitting adoptive current drive) structure, in which top-emission organic electroluminescent elements 11 from which light is extracted from the opposite side to the substrate 10 are provided over the substrate 10 on which TFTs are formed, actively employing this cavity structure allows improvement in the efficiency of light extraction to the external and control of the light emission spectrum.

Over the substrate 10, the organic electroluminescent elements 11 formed in the above-described manner may be used as blue light-emitting elements and red light-emitting elements and green light-emitting elements may be provided in the respective pixels together with the blue light-emitting elements. In this case, full-color displaying may be carried out by forming each one pixel with use of the blue light-emitting element formed of the organic electroluminescent element 11 and the red and green light-emitting elements as a set of sub-pixels, and arranging plural pixels over the substrate 10.

After the first step (S1) of forming the organic electroluminescent element 11 over the substrate 10 is carried out as described above, voltage-decrease treatment for decreasing the operating voltage of the organic electroluminescent element 11 is carried out as the second step (S2). In the second step, a voltage higher than the operating voltage of the organic electroluminescent element 11 is applied between the anode 13 and the cathode 15 in the organic electroluminescent element 11 formed over the substrate 10. Although the light emission of the organic electroluminescent element 11 is controlled by DC-constant-current driving, the voltage applied in the second step (application voltage) may be an AC voltage.

In this voltage-decrease treatment, a voltage is applied to the organic electroluminescent element 11 for a period (e.g. ten seconds or shorter) sufficiently shorter than the voltage application time of the aging treatment for the light emission luminance, described in Patent Document 5. The application voltage is higher than the operating voltage applied in the constant-current driving of the organic electroluminescent element but is lower than the voltage applied in the treatment for repairing a short-circuited part, described in Patent Document 6, and has a voltage value that allows the decreasing of the operating voltage of the organic electroluminescent element. If such a high voltage that an element having a short-circuited part is forcibly caused to emit light and thereby the short-circuited part is repaired is applied to the organic electroluminescent element 11 employing an aluminum alloy for its anode, the breakdown of the organic electroluminescent element 11 will occur. Therefore, it is important in the voltage-decrease treatment that the application voltage be so designed that such breakdown will not occur. It is preferable that the voltage value of such an application voltage be obtained in advance by simulation or experiment as a voltage value allowing the decreasing of the operating voltage of the organic electroluminescent element 11 in the second step.

Furthermore, the application voltage in the second step may be continuously applied, or alternatively may be applied as a pulse by use of a pulse generator or the like. The output waveform (pulse waveform) in the pulse application is selected from a sine wave, triangular wave, rectangular wave (symmetric, asymmetric), and so forth, and a frequency in the band of 0.01 Hz to 1 MHz is preferable as the application frequency. In addition, the application voltage with a pulse waveform may be applied once or plural times.

However, in terms of the power consumption and lifetime of the organic electroluminescent element 11, it is desirable that a voltage be applied efficiently with as low electric energy as possible.

After the step of decreasing the operating voltage of the organic electroluminescent element is carried out as the second step (S2) as described above, so-called aging treatment may be carried out as a step of stabilizing the luminance lowering of the organic electroluminescent element by applying between the anode and the cathode a lower voltage for a longer period compared with the second step. Such aging treatment may be carried out before the voltage-decrease treatment for decreasing the operating voltage of the organic electroluminescent element 11 as the second step (S2).

After the above-described voltage-decrease treatment and aging treatment, a sealing step is carried out as the third step (S3). In the third step, a sealing film for preventing the deterioration of the organic electroluminescent element 11 due to water, oxygen, and so on in the atmosphere is formed in such a manner as to cover the organic electroluminescent element 11, and a counter substrate is attached on the sealing film according to need.

This sealing step may be carried out after the formation of the organic electroluminescent element 11 over the substrate 10 in the first step (S1) and before the decreasing of the operating voltage of the organic electroluminescent element in the second step (S2).

It is confirmed that, according to the above-described manufacturing method, the operating voltage of the organic electroluminescent element 11 is decreased by applying a voltage higher than the operating voltage to the organic electroluminescent element 11 after forming the configuration as the organic electroluminescent element 11, as described later in the explanation of working examples of the present embodiment. Furthermore, it is confirmed that this method can decrease the operating voltage even for the organic electroluminescent element 11 employing an aluminum/neodymium alloy for its anode 13, of which operating voltage is particularly difficult to decrease in related arts. In addition, it is also confirmed that variation in the voltage-current characteristic is suppressed in the organic electroluminescent element 11 manufactured through such voltage-decrease treatment. Moreover, due to the enhancement in characteristics of the organic electroluminescent element 11, the power consumption of a display employing this organic electroluminescent element 11 can be reduced.

In the above-described embodiment, the top-emission organic electroluminescent elements 11 are formed over the substrate 10. However, the manufacturing method of the embodiment is not limited to application to a method for forming the top-emission organic electroluminescent elements 11 and to a TAC structure employing the top-emission organic electroluminescent elements 11, but can be widely applied to manufacturing of the organic electroluminescent element 11 obtained by interposing an organic layer including at least an emission layer between an anode and cathode and to manufacturing of a display employing this organic electroluminescent element 11.

Therefore, the embodiment can be applied also to a configuration obtained by sequentially stacking a cathode, an organic layer, and an anode in that order from the substrate side, and a so-called bottom-emission organic electroluminescent element in which the electrode disposed on the substrate side (lower electrode as the cathode or anode) is formed by using a transparent material and the electrode disposed on the opposite side to the substrate (upper electrode as the cathode or anode) is formed by using a reflective material to thereby allow light extraction only from the substrate side.

Moreover, the organic electroluminescent element according to the embodiment may be any element as long as it is formed by interposing an organic layer between a pair of electrodes (the anode and the cathode). Therefore, the organic electroluminescent element is not limited to an element formed only of a pair of electrodes and an organic layer, and the embodiment will not exclude that other constituents (e.g., inorganic compound layers and inorganic components) are also included in the element without losing an advantageous effect by the embodiment.

<<Schematic Configuration of Display>>

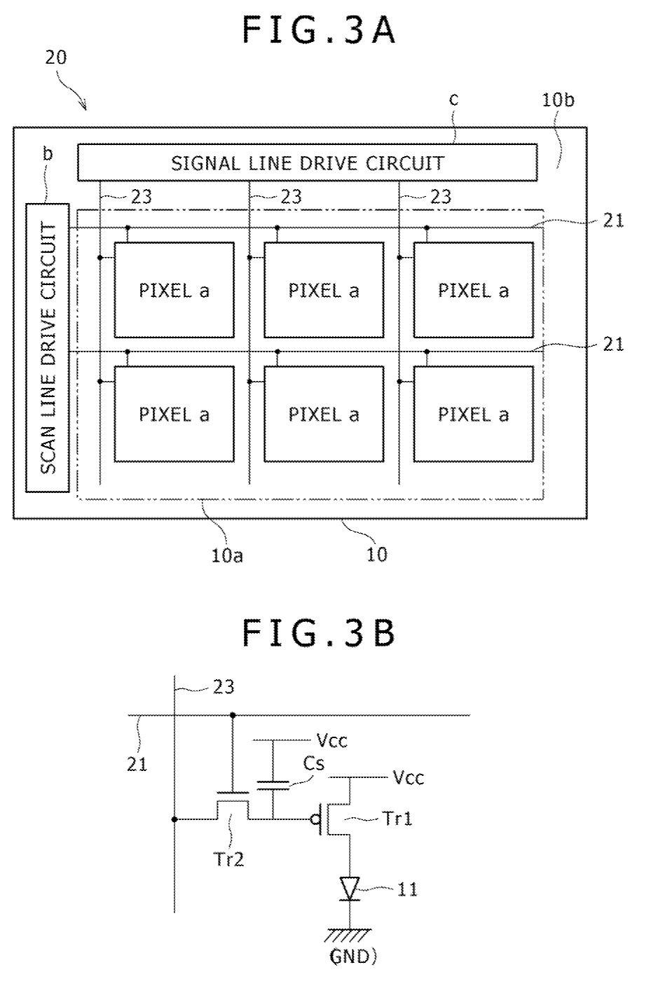

FIG. 3 is a diagram showing one configuration example of a display 20 manufactured by the method according to the embodiment. FIG. 3A is a schematic configuration diagram of the display 20, and FIG. 3B is a diagram showing the configuration of a pixel circuit. In the following, the configuration of the active-matrix display 20 employing the organic electroluminescent elements 11 will be described.

As shown in FIG. 3A, a display area 10a and a peripheral area 10b are defined on the substrate 10 of this display 20. In the display area 10a, plural scan lines 21 and plural signal lines 23 are provided along the horizontal direction and the vertical direction, respectively. The display area 10a is formed as a pixel array part in which one pixel a is provided at each of the intersections between the scan lines 21 and the signal lines 23. In each of the pixels a, the organic electroluminescent element 11 is provided. Provided in the peripheral area 10b are a scan line drive circuit b for scan-driving the scan lines 21 and a signal line drive circuit c for supplying video signals (i.e., input signals) dependent upon luminance information to the signal lines 23.

As shown in FIG. 3B, the pixel circuit provided in each pixel a includes e.g. the organic electroluminescent element 11, a drive transistor Tr1, a write transistor (sampling transistor) Tr2, and a holding capacitor Cs. Due to driving by the scan line drive circuit b, a video signal written from the signal line 23 via the write transistor Tr2 is held in the holding capacitor Cs, and the current dependent upon the amount of the held signal is supplied from the drive transistor Tr1 to the organic electroluminescent element 11, so that the organic electroluminescent element 11 emits light with the luminance dependent upon the current value.

This pixel circuit configuration is merely one example, and the pixel circuit may further include an additional capacitive element and plural transistors according to need. Furthermore, a requisite drive circuit is added to the peripheral area 10b according to the change of the pixel circuit.

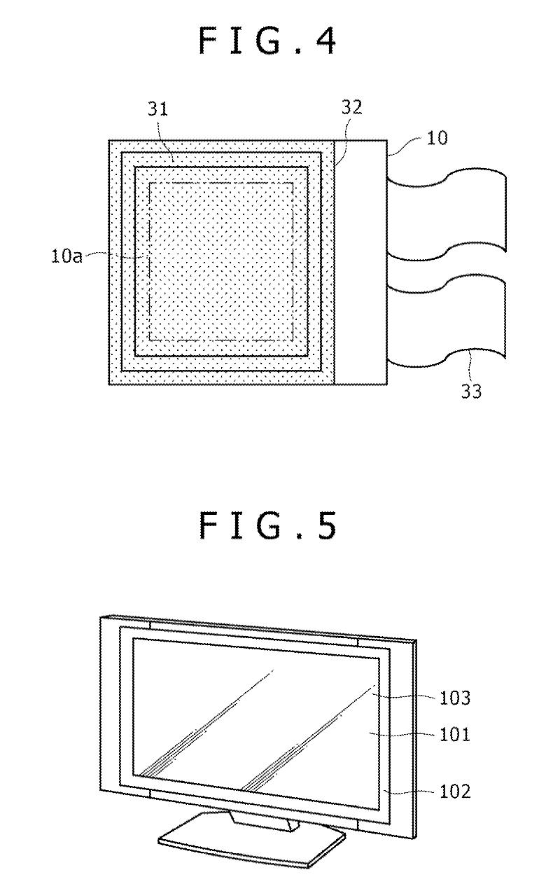

The above-described display 20 according to the embodiment encompasses also a module-shape display with a sealed structure like that shown in FIG. 4. For example, the display module shown in FIG. 4 is formed by providing a sealing part 31 surrounding the display area 10a as a pixel array part and bonding the display to a counter member (sealing substrate 32) such as a transparent glass substrate by use of the sealing part 31 as an adhesive. This transparent sealing substrate 32 may be provided with a color filer, protective film, light-shielding film, and so on. The substrate 10 as the display module on which the display area 10a is formed may be provided with a flexible printed board 33 for external input/output of signals and so on to/from the display area 10a (pixel array part).

### APPLICATION EXAMPLES

The display 20 manufactured by the method according to the embodiment can be applied to various kinds of electronic apparatus shown in FIGS. 5 to 9. Specifically, the display can be used as a display in electronic apparatus in any field that displays a video signal input thereto or produced therein as an image and video, such as a digital camera, notebook personal computer, portable terminal apparatus typified by a cellular phone, and video camera. Examples of electronic apparatus to which the embodiment is applied will be described below.

FIG. 5 is a perspective view showing a television to which the embodiment is applied. This television includes a video display screen 101 formed of a front panel 102, a filter glass 103, and so on, and is fabricated by using the display according to the embodiment as the video display screen 101.

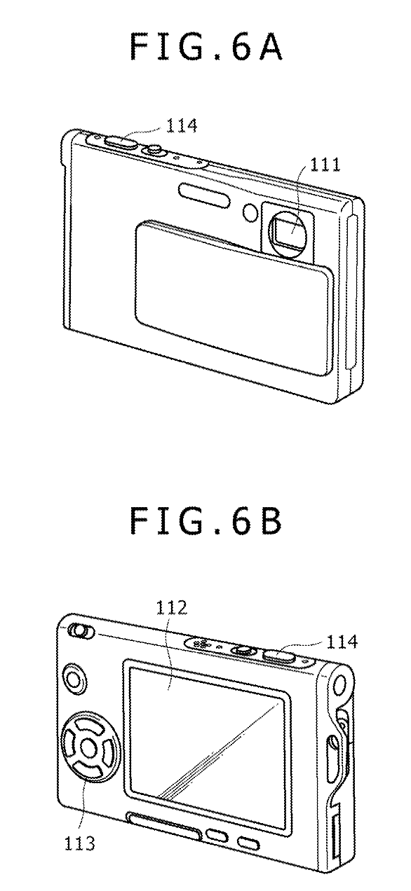

FIG. 6 is a diagram showing a digital camera to which the embodiment is applied. FIG. 6A is a front-side perspective view and FIG. 6B is a rear-side perspective view. This digital camera includes a light emitter 111 for flash, a display part 112, a menu switch 113, a shutter button 114, and so on, and is fabricated by using the display according to the embodiment as the display part 112.

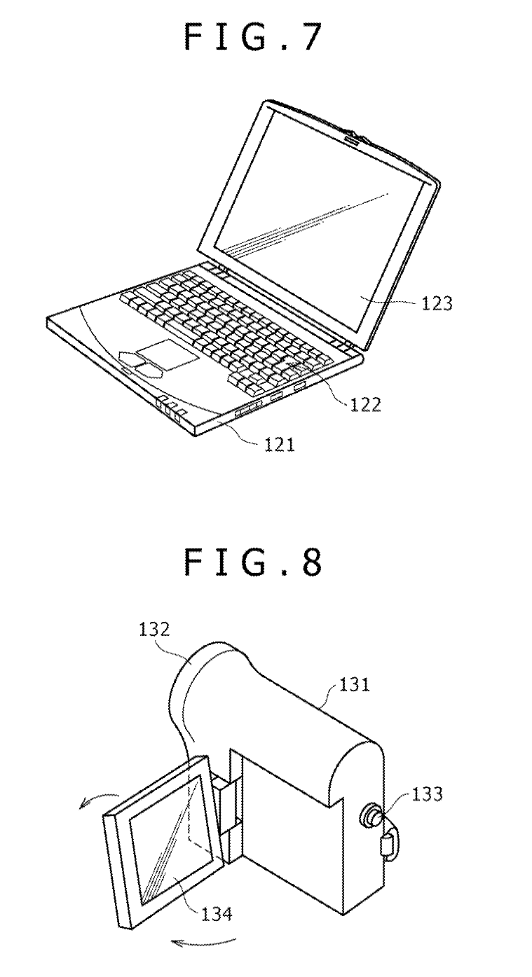

FIG. 7 is a perspective view showing a notebook personal computer to which the embodiment is applied. This notebook personal computer includes in a main body 121 thereof a keyboard 122 operated in inputting of characters and so forth, a display part 123 for displaying images, and so on. The notebook personal computer is fabricated by using the display according to the embodiment as the display part 123.

FIG. 8 is a perspective view showing a video camera to which the embodiment is applied. This video camera includes a main body 131, a lens 132 that is disposed on the front side of the camera and used to capture a subject image, a start/stop switch 133 regarding imaging, a display part 134, and so on. The video camera is fabricated by using the display according to the embodiment as the display part 134.

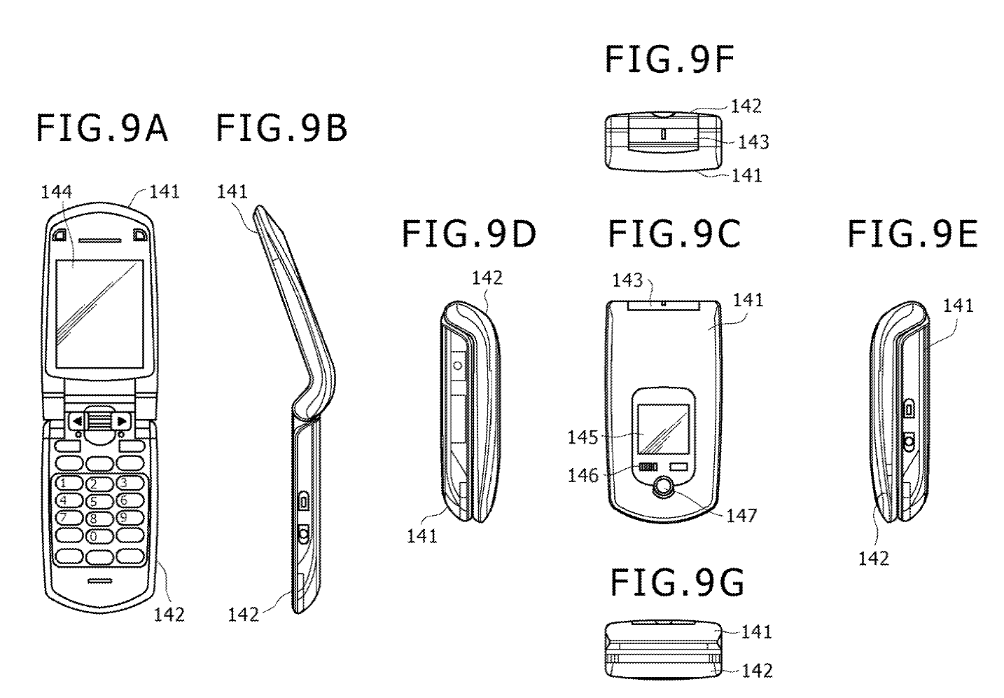

FIG. 9 is a diagram showing a cellular phone as portable terminal apparatus to which the embodiment is applied. FIGS. 9A and 9B are a front view and side view, respectively, of the opened state, and FIGS. 9C, 9D, 9E, 9F, and 9G are a front view, left-side view, right-side view, top view, and bottom view, respectively, of the closed state. This cellular phone includes an upper casing 141, a lower casing 142, a connection (hinge) 143, a display 144, a sub-display 145, a picture light 146, a camera 147, and so on. The cellular phone is fabricated by using the display according to the embodiment as the display 144 and the sub-display 145.

### WORKING EXAMPLES

### Working Examples 1 to 3

In Working examples 1 to 3, the organic electroluminescent element 11 having the configuration shown in FIG. 2 was fabricated by using the manufacturing method explained for the above-described embodiment with use of FIG. 1. The manufacturing procedure will be described below.

Initially, on the substrate 10 formed of a glass plate having a size of 30 mm×30 mm, the anode 13 composed of an aluminum/neodymium (10%) alloy was formed to a thickness of 120 nm. Thereafter, a cell for an organic electroluminescent element was fabricated by masking the anode 13 other than the light emission area with a size of 2 mm×2 mm at the center of the anode 13 with an insulating film (not shown) by SiO₂ evaporation.

Thereafter, the hole injection layer 14a was formed on the anode 13. Specifically, the hole injection layer 14a having a thickness of 15 nm was formed by depositing the material represented by Structural formula (1)-10 shown in Table 1-1 by evaporation (at an evaporation rate of 0.2 to 0.4 nm/sec).

Subsequently, as the hole transport layer 14b, α-NPD (N,N′-bis(1-naphthyl)-N,N′-diphenyl[1,1′-biphenyl]-4,4′-diamine) was deposited to a thickness of 15 nm (at an evaporation rate of 0.2 to 0.4 nm/sec).

Thereafter, for the formation of the emission layer 14c, ADN (9,10-di(2-naphthyl)anthracene) was used as the host, and BD-052x (trade name, by Idemitsu Kosan Co., Ltd) was used as the dopant: these materials were so deposited by vacuum evaporation to a total thickness of 32 nm that the dopant concentration was 5% in the film thickness ratio.

Subsequently, as the electron transport layer 14d, Alq3 (8-hydroxyquinoline aluminum) was evaporated to a thickness of 18 nm.

After the organic layer 14 having the structure arising from the stacking of the hole injection layer 14a to the electron transport layer 14d was formed as described above, a LiF film was formed by vacuum evaporation to a thickness of about 0.3 nm (at an evaporation rate of 0.01 nm/sec) as the first layer 15a of the cathode 15. Subsequently, as the second layer 15b, an MgAg film was formed by vacuum evaporation to a thickness of about 10 nm. By this step, the cathode 15 having a two-layer structure was provided on the organic layer 14.

For the organic electroluminescent element 11 formed in the first step, voltage-decrease treatment in which a DC voltage of 10 V was applied was carried out in the second step. The voltage application time was set to ten seconds, five seconds, and one second in Working examples 1, 2, and 3, respectively, as shown in Table 3.

TABLE 3

| | | | Initial characteristics | | Characteristics after | |
|---|---|---|---|---|---|---|
| | | | (10 mA/cm²) | | driving for 48 h | |
| | | Voltage-decrease | Current | Operating | Current | Operating |
| | Hole injection | treatment 10 V | efficiency | voltage | efficiency | voltage |
| | layer 14a | (application time) | [cd/A] | [V] | [cd/A] | [V] |
| Working example 1 | Structural | 10 seconds | 3.5 | 5.5 | 3.5 | 5.6 |
| Working example 2 | formula | 5 seconds | 3.5 | 5.5 | — | — |
| Working example 3 | (1)-10 | 1 second | 3.5 | 5.5 | 3.5 | 5.6 |
| (Comparative example 1) | | — | 3.5 | 6.5 | — | — |

### Comparative Example 1

In Comparative example 1, for the organic electroluminescent element 11 formed through the same step as the first step in Working examples 1 to 3, the manufacturing procedure that does not include the voltage-decrease treatment as the second step was carried out.

<<Evaluation Result-1>>

Regarding the organic electroluminescent elements 11 of Working examples 1 to 3 and Comparative example 1 obtained in the above-described manner, initial characteristics with respect to a constant current (10 mA/cm²) were measured. The measurement results are also shown in Table 3.

As shown in Table 3, as the initial characteristics, the current efficiency was 3.5 [cd/A] and the operating voltage was 5.5 [V] in the organic electroluminescent elements 11 of Working examples 1 to 3, in which the voltage-decrease treatment was carried out in the second step. In contrast, in the organic electroluminescent element 11 of Comparative example 1, the current efficiency was 3.5 [cd/A] and the operating voltage was 6.5 [V]. From this result, it is proved that the applying of the embodiment, in which the voltage-decrease treatment is carried out in the second step, can decrease the operating voltage by about 1 [V] while keeping the current efficiency, even for the organic electroluminescent element 11 employing an aluminum/neodymium alloy for its anode 13.

Regarding Working examples 1 and 3, characteristics were measured also after the fabricated organic electroluminescent element 11 was driven with a constant current (10 mA/cm²) for 48 hours (h). The measurement results are also shown in Table 3.

As shown by these results, both Working examples 1 and 3 showed the same current efficiency as that of the initial characteristics without suffering from deterioration over time. As for the operating voltage, the voltage value increased to 5.6 [V] after the driving for 48 hours from the initial-characteristic value of 5.5 [V]. However, this increased value was also lower than the initial operating voltage of 6.5 [V] in Comparative example 1. From this result, it is also proved that the applying of the embodiment, in which the voltage-decrease treatment is carried out in the second step, can suppress variation in the voltage-current characteristic, even for the organic electroluminescent element 11 employing an aluminum/neodymium alloy for its anode 13.

Furthermore, the drive characteristic values of the organic electroluminescent elements were identical to each other in Working examples 1 to 3, in which the period of the voltage-decrease treatment was changed from each other. This result proves that even an application time of about one second allows sufficient voltage decreasing in the voltage-decrease treatment with an application voltage of 10 V. This proves that the voltage application time in the voltage-decrease treatment in the embodiment is obviously shorter compared with a treatment time of 6×10¹ sec to 6×10⁵ sec of the aging treatment for stabilizing the lowering of the light emission luminance accompanying the elapse of the light emission time (refer to Patent Document 5, Paragraph 0025).

### Working Example 4

In Working example 4, in the manufacturing procedure including the first and second steps described for Working examples 1 to 3, the material of the hole injection layer 14a deposited in the first step was changed to the substance represented by Structural formula (2)-9 shown in Table 2-1. Furthermore, as shown in Table 4, voltage-decrease treatment in which a DC voltage of 10 V was applied for one second was carried out in the second step.

TABLE 4

| | | | Initial characteristics | |
|---|---|---|---|---|
| | | | (10 mA/cm²) | |
| | Hole | Voltage-decrease | Current | Operating |
| | injection | treatment 10 V | efficiency | voltage |
| | layer 14a | (application time) | [cd/A] | [V] |
| Working | Structural | 1 second | 3.2 | 6.2 |
| example 4 | formula | | | |
| (Comparative | (2)-9 | — | 3.2 | 7.1 |
| example 2) | | | | |

### Comparative Example 2

In Comparative example 2, for the organic electroluminescent element 11 formed through the same step as the first step in Working example 4, the manufacturing procedure that does not include the voltage-decrease treatment as the second step was carried out.

<<Evaluation Result-2>>

Regarding the organic electroluminescent elements 11 of Working example 4 and Comparative example 2 obtained in the above-described manner, initial characteristics with respect to a constant current (10 mA/cm²) were measured. The measurement results are also shown in Table 4.

As shown in Table 4, the current efficiency was 3.2 [cd/A] and the operating voltage was 6.2 [V] in the organic electroluminescent element 11 of Working example 4, in which the voltage-decrease treatment as the second step was carried out. In contrast, in the organic electroluminescent element 11 of Comparative example 2, which did not include the voltage-decrease treatment, the current efficiency was 3.2 [cd/A] and the operating voltage was 7.1 [V]. From this result, it is proved that the applying of the embodiment, in which the voltage-decrease treatment is carried out in the second step, can decrease the operating voltage by about 1 [V] while keeping the current efficiency, even for the organic electroluminescent element 11 that employs the material represented by Structural formula (2)-9 for its hole injection layer 14a and an aluminum/neodymium alloy for its anode 13.

### Working Example 5

In Working example 5, in the manufacturing procedure including the first and second steps described for Working examples 1 to 3, the material of the hole injection layer 14a deposited in the first step was changed to a mixture of the substance represented by Structural formula (2)-9 shown in Table 2-1 and α-NPD (N,N′-bis(1-naphthyl)-N,N′-diphenyl[1,1′-biphenyl]-4,4′-diamine) as a tertiary amine (with a concentration ratio of 50%:50% (1:1)). Furthermore, as shown in Table 5, voltage-decrease treatment in which a DC voltage of 10 V was applied for one second was carried out in the second step.

TABLE 5

| | | | Initial characteristics | |
|---|---|---|---|---|
| | | | (10 mA/cm²) | |
| | Hole | Voltage-decrease | Current | Operating |
| | injection | treatment 10 V | efficiency | voltage |
| | layer 14a | (application time) | [cd/A] | [V] |
| Working | Structural | 1 second | 3.0 | 7.2 |
| example 5 | | | | |
| (Comparative | formula | — | 3.0 | 8.3 |
| example 3) | (2)-9 | | | |
| | and α-NPD | | | |
| | (1:1) | | | |

### Comparative Example 3

In Comparative example 3, for the organic electroluminescent element 11 formed through the same step as the first step in Working example 5, the manufacturing procedure that does not include the voltage-decrease treatment as the second step was carried out.

<<Evaluation Result-3>>

Regarding the organic electroluminescent elements 11 of Working example 5 and Comparative example 3 obtained in the above-described manner, initial characteristics with respect to a constant current (10 mA/cm²) were measured. The measurement results are also shown in Table 5.

As shown in Table 5, the current efficiency was 3.0 [cd/A] and the operating voltage was 7.2 [V] in the organic electroluminescent element 11 of Working example 5, in which the voltage-decrease treatment in the second step was carried out. In contrast, in the organic electroluminescent element 11 of Comparative example 3, which did not include the voltage-decrease treatment, the current efficiency was 3.0 [cd/A] and the operating voltage was 8.3 [V]. From this result, it is proved that the applying of the embodiment, in which the voltage-decrease treatment is carried out in the second step, can decrease the operating voltage by about 1 [V] while keeping the current efficiency, even for the organic electroluminescent element 11 that employs a mixture containing the above-described tertiary amine for its hole injection layer 14a and an aluminum/neodymium alloy for its anode 13.

As described above, it is proved that the manufacturing method according to the embodiment can provide an organic electroluminescent element that has favorable characteristics including a decreased operating voltage and suppressed variation in the voltage-current characteristic.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for manufacturing an organic electroluminescent element, the method comprising:
after forming the organic electroluminescent element obtained by interposing an emission layer composed of an organic material between an anode and a cathode, decreasing an operating voltage of the organic electroluminescent element by applying a voltage higher than the operating voltage of the organic electroluminescent element between the anode and the cathode.

2. The method for manufacturing the organic electroluminescent element according to claim 1, wherein
in the decreasing an operating voltage, a voltage having a pulse waveform is applied between the anode and the cathode.

3. The method for manufacturing the organic electroluminescent element according to claim 1, wherein
in the decreasing an operating voltage, voltage application between the anode and the cathode is carried out a plurality of times.

4. The method for manufacturing the organic electroluminescent element according to claim 1, further comprising the step of
before or after the decreasing an operating voltage, stabilizing luminance lowering of the organic electroluminescent element by applying between the anode and the cathode a voltage lower than the voltage applied in the decreasing an operating voltage for a period longer than a voltage application time in the decreasing an operating voltage.

5. The method for manufacturing the organic electroluminescent element according to claim 1, wherein
the anode is formed by using an aluminum alloy that contains, as a minor component, an element having a work function lower than a work function of aluminum.

6. The method for manufacturing the organic electroluminescent element according to claim 5, wherein
a minor component in the aluminum alloy of the anode is a lanthanoid series element.

7. The method for manufacturing the organic electroluminescent element according to claim 1, wherein
a layer formed by using a material represented by General formula (1) is so disposed between the anode and the emission layer as to be in contact with the anode, 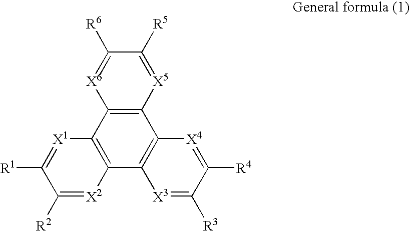
where R¹ to R⁶ are each independently a substituent selected from hydrogen, a halogen, a hydroxyl group, an amino group, an arylamino group, a substituted or unsubstituted carbonyl group having 20 or less carbon atoms, a substituted or unsubstituted carbonyl ester group having 20 or less carbon atoms, a substituted or unsubstituted alkyl group having 20 or less carbon atoms, a substituted or unsubstituted alkenyl group having 20 or less carbon atoms, a substituted or unsubstituted alkoxyl group having 20 or less carbon atoms, a substituted or unsubstituted aryl group having 30 or less carbon atoms, a substituted or unsubstituted heterocyclic group having 30 or less carbon atoms, a nitrile group, a cyano group, a nitro group, and a silyl group, adjacent R^{m}(m=1 to 6) may be coupled to each other via a ring structure, and X¹ to X⁶ are each independently a carbon atom or a nitrogen atom.

8. The method for manufacturing the organic electroluminescent element according to claim 1, wherein
a layer formed by using a material represented by General formula (2) is so disposed between the anode and the emission layer as to be in contact with the anode, 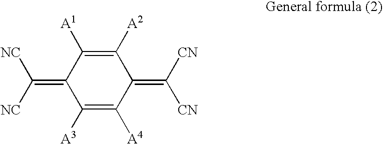
where A¹ to A⁴ are each independently a substituent selected from hydrogen, a halogen, a hydroxyl group, an amino group, an arylamino group, a substituted or unsubstituted carbonyl group having 20 or less carbon atoms, a substituted or unsubstituted carbonyl ester group having 20 or less carbon atoms, a substituted or unsubstituted alkyl group having 20 or less carbon atoms, a substituted or unsubstituted alkenyl group having 20 or less carbon atoms, a substituted or unsubstituted alkoxyl group having 20 or less carbon atoms, a substituted or unsubstituted aryl group having 30 or less carbon atoms, a substituted or unsubstituted heterocyclic group having 30 or less carbon atoms, a nitrile group, a cyano group, a nitro group, and a silyl group, and adjacent A^{m}, m=1 to 4, may be coupled to each other via a ring structure.

9. A method for manufacturing a display, the method comprising:
after arranging over a substrate a plurality of organic electroluminescent elements that are each obtained by interposing an emission layer composed of an organic material between an anode and a cathode, decreasing an operating voltage of the organic electroluminescent element by applying a voltage higher than the operating voltage of the organic electroluminescent element between the anode and the cathode.
